(19) United States
(12) Patent Application Publication
(10) Pub. No.: US 2011/0302130 A1
(43) Pub. Date: Dec. 8, 2011

(54) INTELLIGENT VIDEO INFORMATION RETRIEVAL APPARATUS AND METHOD CAPABLE OF MULTI-DIMENSIONAL VIDEO INDEXING AND RETRIEVAL

(75) Inventors: Han-Sung LEE, Yongin (KR); Yun-Su Chung, Daejeon (KR); Jeong-Nyeo Kim, Daejeon (KR); Ki-Young Moon, Daejeon (KR); So-Hee Park, Daejeon (KR); Yong-Jin Lee, Ansan (KR)

(73) Assignee: Electronics and Telecommunications Research Institute, Daejeon (KR)

(21) Appl. No.: 13/151,718

(22) Filed: Jun. 2, 2011

(30) Foreign Application Priority Data
Jun. 3, 2010 (KR) 10-2010-0052476

(51) Int. Cl. G06F 17/30

(52) U.S. Cl. 707/602; 707/E17.005

(57) ABSTRACT

Provided is an intelligent video information retrieval apparatus capable of multi-dimensional video indexing and retrieval. The intelligent video information retrieval apparatus includes an event detector configured to detect pieces of event information from footage collected by a plurality of video capture devices, a data mart builder configured to generate a data cube using the detected pieces of event information, and capture time and capture location information related to the pieces of event information, and store and manage the generated data cube, and a video retriever configured to receive an event retrieval condition from a user to retrieve event information corresponding to the received event retrieval condition using the data cube, and output the retrieval result to the user.

### CROSS REFERENCE TO RELATED APPLICATION

This application claims priority to Korean Patent Application No. 10-2010-0052476 filed on Jun. 3, 2010, which is hereby incorporated by reference in its entirety into this application.

### BACKGROUND OF THE INVENTION

1. Technical Field

Example embodiments of the present invention relate in general to an apparatus for retrieving video information, and more specifically, to an intelligent video information retrieval apparatus and method capable of multi-dimensional video indexing and retrieval.

2. Description of the Related Art

For the purposes of remote prevention of crimes, remote surveillance and crime investigation in public areas, installation and use of a closed-circuit television (CCTV) is drastically increasing. In general, a CCTV system consists of three components: 1) a camera unit which is installed at a site to be monitored and monitors the target area; 2) a scene control unit which is installed at the site where the camera is installed and is connected with the camera unit to store and transfer vision data; 3) a remote control unit which monitors and manages the received vision data.

CCTV systems are used for the following two major purposes.

One is to remotely prevent crimes by real-time transmission of video information about a monitored area, and the other is to support a crime investigation at the initial stage using stored video information when a crime occurs.

It is a well-known investigation technique to detect a crime suspect and a suspect vehicle by analyzing CCTV footage of a crime scene and surroundings of the crime scene when the crime occurs. However, conventional CCTV systems simply store footage transmitted from a camera installed and managed at a site, or employ a very simple index structure according to time, thus finding clues from footage in manual way is very difficult and time-consuming process. For example, to analyze three days of CCTV footage that includes the scene of the crime, an investigator should watch and find the clues for tracking the culprit down from the three days of footage firsthand.

To meet aforementioned difficulty, in general, a user analyzes footage firsthand while the footage is played at high speed. In this case, the high-speed playback of footage reduces an overall video analysis time, but involves a person in simultaneously watching and analyzing all of the footage firsthand, which is labor-intensive work. In addition, since the footage is played at high speed, a user may pass over some portions.

In another method for dealing the above problems, an event such as a movement is detected from the footage, and only a portion of the footage corresponding to the detected event is retrieved.

However, in this method, only one-dimensional indexing can be performed, separately on respective pieces of footage captured by a plurality of cameras, regardless of relationships between several correlated pieces of footage.

Consequently, this method cannot make use of much latent information, or makes it difficult to use the information.

### SUMMARY OF THE INVENTION

Accordingly, example embodiments of the present invention are provided to substantially obviate one or more problems due to limitations and disadvantages of the related art.

Example embodiments of the present invention provide an intelligent video information retrieval apparatus and method capable of multi-dimensional video indexing and retrieval.

More specifically, example embodiments of the present invention provide a video information retrieval apparatus and method which build a data mart on the basis of information, such as an event, a capture time, and a capture location, included in pieces of evidential footage collected by a plurality of closed-circuit television (CCTV) cameras, enable hierarchical retrieval and semantic analysis using the data mart, and thus enable rapid retrieval and analysis of the pieces of evidential footage when a crime occurs.

In some example embodiments, an intelligent video information retrieval apparatus capable of multi-dimensional video indexing and retrieval includes: an event detector configured to detect pieces of event information from footage collected by a plurality of video capture devices; a data mart builder configured to generate a data cube using the detected pieces of event information, and capture time and capture location information related to the pieces of event information, and store and manage the generated data cube; and a video retriever configured to receive an event retrieval condition from a user to retrieve event information corresponding to the received event retrieval condition using the data cube, and output the retrieval result to the user.

In other example embodiments, an intelligent video information retrieval method capable of multi-dimensional video indexing and retrieval includes: detecting pieces of event information from footage collected by a plurality of video capture devices; generating a data cube using the detected pieces of event information, and capture time and capture location information related to the pieces of event information; storing and managing the generated data cube; receiving an event retrieval condition from a user; retrieving event information corresponding to the received event retrieval condition using the data cube; and outputting the retrieval result to the user.

### BRIEF DESCRIPTION OF THE DRAWINGS

Example embodiments of the present invention will become more apparent by describing in detail example embodiments of the present invention with reference to the accompanying drawings, in which:

FIG. 1 is a block diagram of an intelligent closed-circuit television (CCTV) system capable of multi-dimensional video indexing and retrieval according to example embodiments of the present invention;

FIG. 2 is a block diagram illustrating a detailed structure of a video information retrieval server shown in FIG. 1;

FIGS. 3 and 4 illustrate a data cube employed in example embodiments of the present invention; and

FIG. 5 is a flowchart illustrating an intelligent video information retrieval method capable of multi-dimensional video indexing and retrieval according to example embodiments of the present invention.

### DESCRIPTION OF THE PREFERRED EMBODIMENTS

Example embodiments of the present invention are disclosed herein. However, specific structural and functional details disclosed herein are merely representative for purpose of describing example embodiments of the present invention, however, example embodiments of the present invention may be embodied in many alternate forms and should not be construed as limited to example embodiments of the present invention set forth herein. The true scope of the present invention is intended to encompass all modifications, equivalents, and alternatives falling within the spirit and scope of the appended claims. Throughout the drawings and detailed description, effort has been made to denote each element by the same, unchanging reference numeral.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other terms used to describe relationships between elements should be interpreted in a like fashion (e.g., “between” versus “directly between,” “adjacent” versus “directly adjacent,” etc.).

Elements referred to as singular using “a,” “an” and “the,” may also be pluralities unless the context clearly indicates otherwise. It will be further understood that the terms “comprises,” “comprising,” “includes” and/or “including,” when used herein, specify the presence of stated features, numbers, steps, elements, and/or components, but do not preclude the presence or addition of one or more other features, numbers, steps, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently, or the blocks may sometimes be executed in the reverse order, depending upon the functionality/acts involved.

An intelligent video information retrieval apparatus and method capable of multi-dimensional video indexing and retrieval according to example embodiments of the present invention will be described below with reference to the appended drawings.

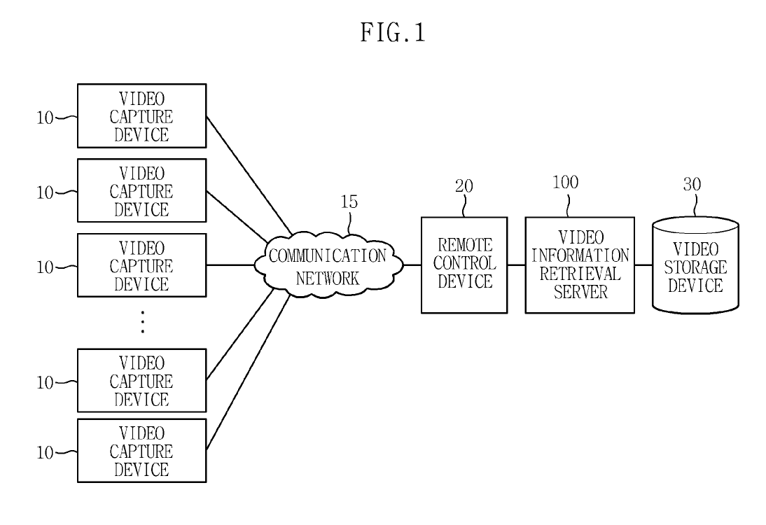

FIG. 1 is a block diagram of an intelligent closed-circuit television (CCTV) system capable of multi-dimensional video indexing and retrieval according to example embodiments of the present invention.

Referring to FIG. 1, a CCTV system according to example embodiments of the present invention includes a plurality of video capture devices 10, a remote control device 20, a video information retrieval server 100, and a video storage device 30.

The remote control device 20 is connected with the plurality of video capture devices 10 via the communication network 15.

The video information retrieval server 100 obtains footage captured by the video capture devices 10 through the remote control device 20.

The video storage device 30 stores the evidential footage captured by the video capture devices 10.

In this case, a “video information retrieval server” corresponds to an “apparatus for retrieving video information” recited in claims.

The video capture devices 10 are installed in a specific area and capture footage of the area with high picture quality (e.g., high-definition (HD) picture quality). The video capture devices 10 have capturing means such as HD CCTV cameras and control means for storing video data obtained by the capturing means in storing means and transmitting the video data stored in the storing means to the remote control device 20 via the communication network 15.

The remote control device 20 monitors, manages, and stores the data received from the video capture devices 10.

In response to an information request of the video information retrieval server 100, the remote control device 20 provides the video data collected from the plurality of video capture devices 10 to the video information retrieval server 100. In the CCTV system according to example embodiments of the present invention, the remote control device 20 can be omitted, according to an installation environment.

The video information retrieval server 100 performs two main roles.

A first role is generating, storing, and managing a data cube on the basis of event information collected by the video capture devices 10, and a second role is retrieving event information corresponding to an event retrieval condition received from a user using the stored data cube and then providing the retrieval result to the user.

More specifically, the video information retrieval server 100 detects pieces of event information from footage collected by the plurality of video capture devices 10, generates a data cube using the detected pieces of event information, and capture times and capture locations (in general, identifications (IDs) related to respective video capture devices) of the pieces of event information, and stores and manages the generated data cube. In this case, the video information retrieval server 100 may receive the footage collected by the plurality of video capture devices 10 directly from the respective video capture devices 10 via the communication network 15, or indirectly via an external storage device (e.g., an external hard disk drive (HDD) or a universal serial bus (USB)).

Also, the video information retrieval server 100 receives an event retrieval condition from a user, hierarchically retrieves event information corresponding to the received event retrieval condition using the stored data cube, semantically analyzes the retrieval result, and then provides the retrieval result and the analysis result to the user.

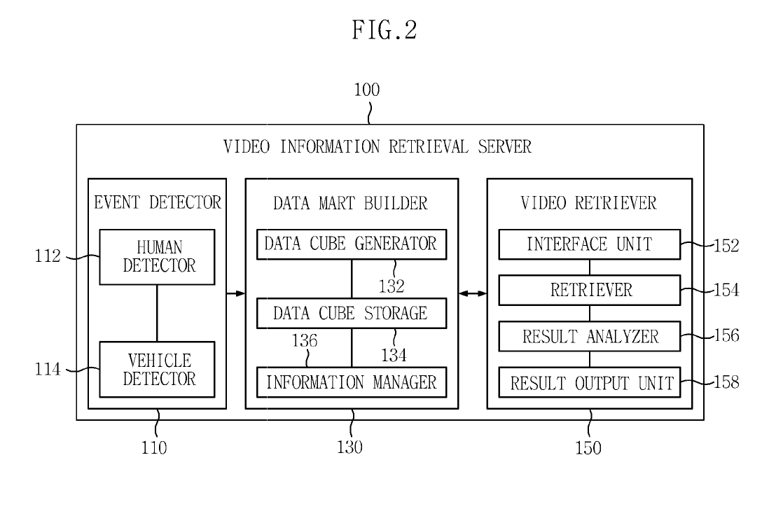

A structure and functions of the video information retrieval server 100 will be described in detail later with reference to FIG. 2.

The video storage device 30 stores and manages data of the evidential footage captured by the plurality of video capture devices 10. In response to a request from the video information retrieval server 100, the video storage device 30 provides required evidential footage data to the video information retrieval server 100.

FIG. 2 is a block diagram illustrating a detailed structure of the video information retrieval server shown in FIG. 1.

Referring to FIG. 2, a video information retrieval server 100 according to example embodiments of the present invention includes an event detector 110, a data mart builder 130, and a video retriever 150.

The event detector 110 detects pieces of major event information from footage collected by a plurality of video capture devices.

In example embodiments of the present invention, the major event information denotes event information required for a criminal investigation, such as motion of a captured object, a face, a clothing color, a vehicle type, a vehicle model, a vehicle color, and a vehicle license plate. In other words, event information is not limited to specific event information in example embodiments of the present invention, and refers to all event information that can be used for a criminal investigation as mentioned above.

The event detector 110 includes a human detector 112 and a vehicle detector 114.

The human detector 112 detects event information related to human from the footage collected by the plurality of video capture devices and transfers the detected event information to the data mart builder 130. In this case, the event information related to human can be a motion, a face, a clothing color, etc. of a person.

The vehicle detector 114 detects event information related to vehicles from the footage collected by the plurality of video capture devices and transfers the detected event information to the data mart builder 130. In this case, the event information related to vehicles can be a movement, a key point, a color, a license plate, etc. of a vehicle.

The data mart builder 130 generates a data cube using pieces of event information detected by the event detector 110 and information (capture times, capture locations, etc.) related to the pieces of event information, and stores and manages the generated data cube. In general, capture times and capture locations related to the corresponding pieces of event information can be found through metadata (a time, and an ID of a video capture device) included in footage.

The data mart builder 130 includes a data cube generator 132, a data cube storage 134, and an information manager 136.

The data cube generator 132 generates a data cube using the pieces of event information detected by the event detector 110 and capture time and capture location information related to the pieces of event information.

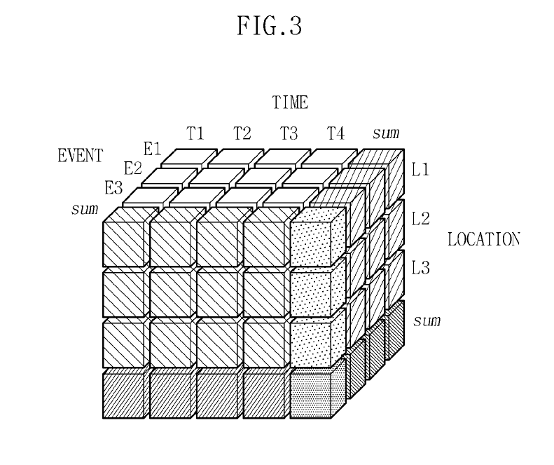

FIG. 3 illustrates a data cube employed in example embodiments of the present invention. The data cube of FIG. 3 has three dimensions of capture time, capture location, and event. Frames of each piece of footage from which an event is detected are disposed along a time axis, a location axis, and an event axis, and classified after different IDs are given to the frames disposed at respective coordinates. However, a data cube model employed in example embodiments of the present invention is not limited to three dimensions, and can have more than three dimensions, as required.

In this case, information in each dimension is hierarchically classified.

The time axis has a hierarchical structure of, for example, seconds, minutes, days, weeks, months, and years, and all times can be expressed by a set of values, one for every level of the hierarchy.

The location axis has a hierarchical structure of, for example, street, village, town, city, county, and state in which each video capture device is installed, and the hierarchical structure may vary according to example embodiments.

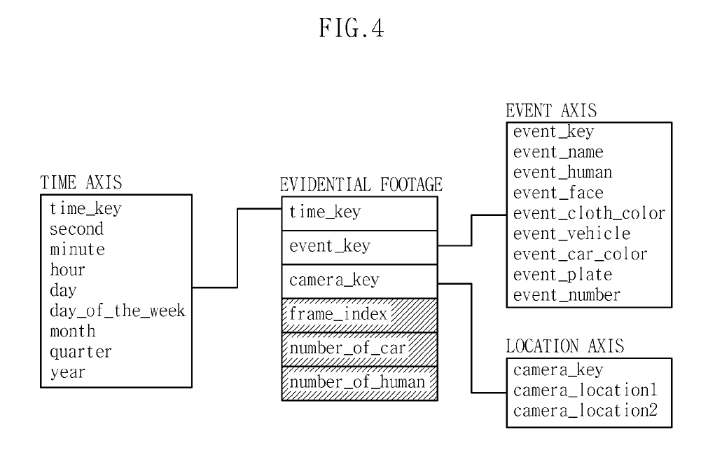

On the event axis, all events are classified into, for example, humans or vehicles, according to a specific concept. An event of humans can be classified into, for example, a case in which a face is recognized and a case in which a face is not recognized, so that a hierarchical structure can be constructed according to a specific concept. An example embodiment of the above-mentioned data cube model is shown in FIG. 4. FIG. 4 shows the most general star schema model of a data cube.

The data cube storage 134 stores the data cube generated by the data cube generator 132.

The information manager 136 manages the data cube stored in the data cube storage 134 and evidential footage stored in the video storage device 30 of FIG. 1.

The video retriever 150 receives an event retrieval condition from a user, hierarchically retrieves event information corresponding to the received event retrieval condition using the data cube generated by the data mart builder 130, semantically analyzes the retrieval result, and then provides the retrieval result and the analysis result to the user.

To this end, the video retriever 150 includes an interface unit 152, a retriever 154, a result analyzer 156, and a result output unit 158.

The interface unit 152 provides an interface for retrieval to the user. In other words, the interface unit 152 provides a user interface for receiving an event retrieval condition (e.g., a period, a location, and a zone) from the user. Through the interface unit 152, the user can input a retrieval condition (e.g., a period, a location, and an event) of evidential footage to be retrieved from the data cube built by the data mart builder 130.

The retriever 154 hierarchically retrieves event information corresponding to the event retrieval condition received from the user through the interface unit 152 using the data cube stored in the data mart builder 130, and transfers the retrieval result to the result analyzer 156. Also, the retriever 154 processes the retrieval result to be output to the user through the result output unit 158.

The retriever 154 can be implemented using an online analytical processing (OLAP) engine. In particular, the user can set a variety of event retrieval conditions using roll-up, drill-down, slice, and dice functions of an OLAP engine.

For example, the user can retrieve evidential footage, which is related to all video capture devices and all events corresponding to a specific period, using the slice function. Also, the user can retrieve evidential footage corresponding to a specific video capture device, a specific time, and a specific event using the dice function.

The result analyzer 156 semantically analyzes the retrieval result received from the retriever 154 and extracts pieces of meaningful information only. Also, the result analyzer 156 processes the result to be output to the user through the result output unit 158.

The result output unit 158 outputs the retrieval result of the retriever 154 and the analysis result of the result analyzer 156 to the user.

As described above, footage collected by video capture devices (i.e., evidential footage) can be internally and systematically classified, and hierarchical retrieval and analysis of a meaning level can be performed in a multi-dimensional structure of the evidential footage.

For example, only scenes in which a vehicle is detected can be retrieved from footage captured during a specific period by all video capture devices installed at a specific location. As the retrieval result, all vehicles monitored by the video capture devices can be seen from the scenes in which a vehicle is detected in time sequence.

When the license plate of a suspect vehicle is recognized, only scenes in which a license plate is recognized can be retrieved to piece together a travel route, etc. of the vehicle in regular time sequence using the IDs of video capture devices that have captured footage of the vehicle.

Meanwhile, the above-described example embodiment is one of numerous retrieval scenarios enabled using an apparatus for retrieving video information according to example embodiments of the present invention, and various other meaningful retrievals can be performed. Needless to say, the above-described scenario can be applied to humans as is.

In the case of a conventional data cube model, respective cells constituting each cube store numerical data, and thus data of cells corresponding to a specific retrieval condition can be summed by numerical computation such as an aggregation function.

However, in the case of a data cube model according to example embodiments of the present invention, meaningful data cannot be obtained by summing numeric data stored in respective cells, and thus such an aggregation function cannot be simply applied.

In example embodiments of the present invention, a list of frames is generated using a data structure in the form of a list, thereby solving a problem of conventional art. In other words, frames corresponding to an event retrieval condition are retrieved from a data cube to generate one event list.

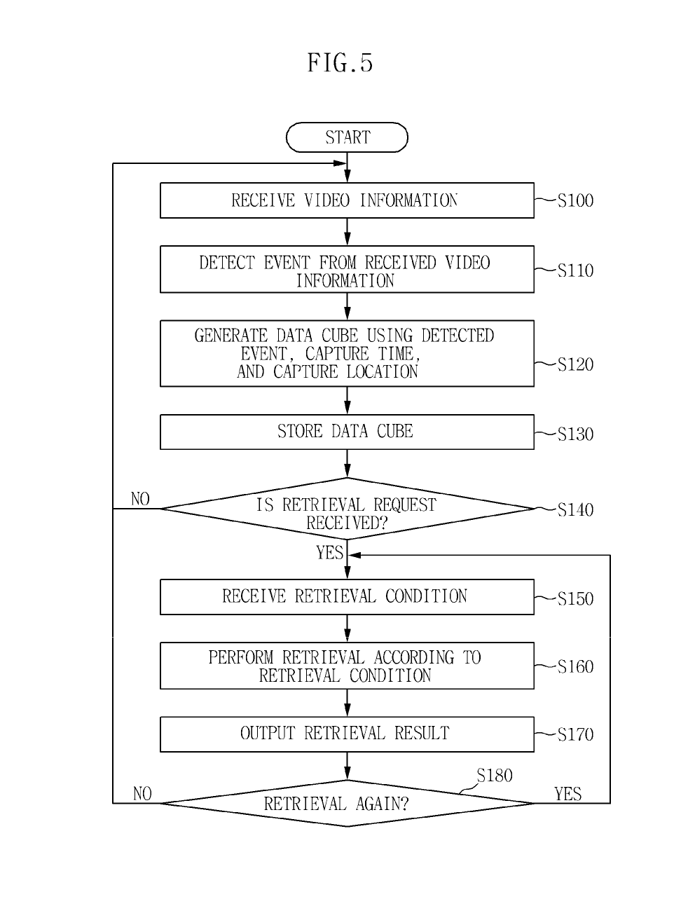

FIG. 5 is a flowchart illustrating an intelligent video information retrieval method capable of multi-dimensional video indexing and retrieval according to example embodiments of the present invention.

The intelligent video information retrieval method capable of multi-dimensional video indexing and retrieval according to example embodiments of the present invention includes detecting pieces of event information from footage collected by a plurality of video capture devices, generating a data cube using the detected pieces of event information, and capture time and capture location information related to the pieces of event information, storing and managing the generated data cube, receiving an event retrieval condition from a user, and retrieving event information corresponding to the received event retrieval condition using the data cube.

Referring to FIG. 5, first, an apparatus for retrieving video information according to example embodiments of the present invention receives footage collected by a plurality of video capture devices (S100).

Subsequently, the apparatus detects pieces of major event information from the footage received in ‘S100’ (S110). In this case, the major event information denotes event information required for a criminal investigation, such as motion, face, clothing color, vehicle type, vehicle model, vehicle color, and vehicle license plate of a captured object.

Subsequently, the apparatus generates a data cube using the pieces of event information detected in ‘S110’ and related information (information about a capture time, a capture location, etc.) (S120). Then, the apparatus stores and manages the data cube generated in ‘S120’ (S130).

Subsequently, the apparatus determines whether a request for event retrieval is received from a user (S140).

When it is determined in ‘S140’ that a request for event retrieval is received from a user, an event retrieval condition is set by the user (S150). Then, the apparatus hierarchically retrieves event information corresponding to the event retrieval condition set in ‘S150’ using the data cube stored in ‘S130’ (S160).

Subsequently, the apparatus outputs the retrieval result of ‘S160’ to the user (S170).

When a retrieval-again request is received from the user after the retrieval result is provided to the user in ‘S170’, the process proceeds to ‘S150’, and the apparatus receives an event retrieval condition by the user again and repeats the above-described process.

Example embodiments of the present invention have the following effects. First, the example embodiments enable initial management of a crime detected from footage captured by a CCTV camera installed and used at a site, etc., and concentrated management for preventing and clearing crimes through rapid retrieval of video information stored and indexed when an incident occurs. Consequently, it is possible to reduce the load of labor-intensive work such as suspect identification, and concentrate on arresting criminals.

Second, the example embodiments detect events from evidential footage collected by CCTV cameras and build a data mart using the detected events and additional information such as a capture time and capture location related to the events, thereby enabling hierarchical retrieval and semantic analysis. Consequently, retrieval of an event which becomes a major clue in a criminal investigation and a semantic relationship is facilitated.

Third, the example embodiments will spark the development of a security industry that employs surveillance cameras such as a CCTV cameras and intelligent next-generation CCTV systems capable of directly aiding in criminal investigations, and employs a framework of scientific investigations instead of a conventional CCTV system limited to simple indexing and retrieval of footage.

While the example embodiments of the present invention and their advantages have been described in detail, it should be understood that various changes, substitutions and alterations may be made herein without departing from the scope of the invention.

What is claimed is:

1. An apparatus for retrieving video information, comprising:
an event detector configured to detect pieces of event information from footage collected by a plurality of video capture devices;
a data mart builder configured to generate a data cube using the detected pieces of event information, capture time and capture location information related to the pieces of event information, and store and manage the generated data cube; and
a video retriever configured to receive an event retrieval condition from a user to retrieve event information corresponding to the received event retrieval condition using the data cube, and output the retrieval result to the user.

2. The apparatus according to claim 1, wherein the detected pieces of event information, capture time and capture location information correspond to dimensions of the data cube.

3. The apparatus according to claim 2, wherein the dimensions of the data cube have hierarchical structures, respectively.

4. The apparatus according to claim 3, wherein the capture time information corresponds to a hierarchical structure of seconds, minutes, days, weeks, months, and years.

5. The apparatus according to claim 4, wherein the capture location information corresponds to a hierarchical structure of street, village, town, city, county, and state.

6. The apparatus according to claim 5, wherein the video retriever hierarchically retrieves event information corresponding to the received event retrieval condition using at least one dimension of the data cube.

7. The apparatus according to claim 5, wherein the video retriever is implemented using an online analytical processing (OLAP) engine.

8. The apparatus according to claim 1, wherein the detected pieces of event information correspond to at least one of motion of a captured object, a face, a clothing color, a vehicle type, a vehicle model, a vehicle color, and a vehicle license plate.

9. The apparatus according to claim 8, wherein the event detector comprises a human detector which detects event information related to human from the footage collected by the plurality of video capture devices and a vehicle detector which detects event information related to vehicles from the footage.

10. The apparatus according to claim 9, wherein the data mart builder generates the data cube using metadata included in the footage.

11. A method of retrieving video information, comprising:
detecting pieces of event information from footage collected by a plurality of video capture devices;
generating a data cube using the detected pieces of event information, and capture time and capture location information related to the pieces of event information;
receiving an event retrieval condition from a user;
retrieving event information corresponding to the received event retrieval condition using the data cube; and
outputting the retrieval result to the user.

12. The method according to claim 11, wherein the detected pieces of event information, and capture time and capture location information correspond to dimensions of the data cube and the dimensions of the data cube have hierarchical structures, respectively.

13. The method according to claim 12, wherein the capture time information corresponds to a hierarchical structure of seconds, minutes, days, weeks, months, and years.

14. The method according to claim 13, wherein the capture location information corresponds to a hierarchical structure of street, village, town, city, county, and state.

15. The method according to claim 14, wherein the retrieving the event information retrieves the event information corresponding to the received event retrieval condition using at least one dimension of the data cube.

16. The method according to claim 11, wherein the detected pieces of event information correspond to at least one of motion of a captured object, a face, a clothing color, a vehicle type, a vehicle model, a vehicle color, and a vehicle license plate.

17. The method according to claim 16, wherein the generating the data cube generates the data cube using metadata included in the footage.
